(19) United States
(12) Patent Application Publication
(10) Pub. No.: US 2011/0026745 A1
(43) Pub. Date: Feb. 3, 2011

(54) DISTRIBUTED SIGNAL PROCESSING OF IMMERSIVE THREE-DIMENSIONAL SOUND FOR AUDIO CONFERENCES

(76) Inventors: Amir Said, Cupertino, CA (US); Ton Kalker, Carmel, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/533,260

(22) Filed: Jul. 31, 2009

(51) Int. Cl. H04R 5/02

(52) U.S. Cl. 381/310; 381/300; 381/309

(57) ABSTRACT

Embodiments of the present invention are directed to audio-conference communication systems that enable audio-conference participants to identify which of the participants are speaking. In one embodiment, an audio-communication system comprises at least one communications server, a plurality of stereo sound generating devices, and a plurality of microphones. Each stereo sound generating device is electronically coupled to the at least one communications server, and each microphone is electronically coupled to the at least one communications server. Each microphone detects different sounds that are sent to the at least one communications server as corresponding sound signals. The at least one communications server converts the sound signals into corresponding stereo signals that when combined and played over each of stereo sound generating devices creates an impression for a person listing to any one of the stereo sound generating devices that each of the sounds emanates from a different virtual location in three-dimensional space.

### TECHNICAL FIELD

Embodiments of the present invention are related to sound signal processing.

### BACKGROUND

Increasing interest in communications systems, such as the Internet, electronic presentations, voice mail, and audio-conference communication systems, is increasing the demand for high-fidelity audio and communication systems. Currently, individuals and businesses are using these communication systems to increase efficiency and productivity, while decreasing cost and complexity. For example, when people participating in a meeting cannot be simultaneously in the same conference room, audio-conference communication systems enable one or more participants at a first location to simultaneously converse with one or more participants at other locations through full-duplex communication lines in real time. As a result, audio-conference communication systems have emerged as one of the most used tools for audio conferencing.

However, the effectiveness of distributed audio conferencing can be constrained by the limitations of the communication systems. For instance, as the number of people participating in an audio conference increases, it becomes more difficult for listeners to identify the person speaking. The effort needed to identify a speaker may be distracting and greatly reduces social interactions that would otherwise occur naturally had the same meeting been carried out in person. While video conferencing partially addresses a few of these interaction problems, for many individuals and businesses, video conferencing systems are cost prohibitive.

Designers, manufacturers, and users of audio-conference communication systems continue to seek enhancements in audio-conference experience.

### BRIEF DESCRIPTION OF THE DRAWINGS

FIGS. 1A-1B show a top view a person listening to a sound generated by a sound source in two different locations.

FIG. 2 shows filters schematically representing the computational operation of converting a sound signal into left ear and right ear auditory canal signals

FIG. 3 shows an example of a spherical coordinate system with the origin located at the center of a model person's head.

FIG. 4 shows a top view and schematic representation of using headphones and stereo sound to approximate the sounds generated by the sound source, shown in FIG. 1A.

FIG. 5 shows a schematic representation of an audio conference with virtual participant locations in three-dimensional space in accordance with embodiments of the present invention.

FIG. 6 shows a diagram of sound signals filtered and combined to create stereo signals in accordance with embodiments of the present invention.

FIG. 7 shows a diagram of sound signals filtered and combined in the frequency domain to create stereo signals in accordance with embodiments of the present invention.

FIG. 8A shows top views of a listening participant and virtual locations for three other speaking participants as perceived by the listening participant in accordance with embodiments of the present invention.

FIG. 8B shows a diagram of how sound signals are processed with head-orientation data to create stereo signals in accordance with embodiments of the present invention.

FIG. 9 shows a schematic representation of an audio conference with virtual room locations in three-dimensional space in accordance with embodiments of the present invention.

FIG. 10 shows a schematic representation of an audio conference with simulated three-dimensional locations of rooms and individual participants participating in an audio conference in accordance with embodiments of the present invention.

FIG. 11 shows a schematic representation of a first audio-conference system for facilitating an audio conference with virtual locations for participants in accordance with embodiments of the present invention.

FIG. 12 shows a schematic representation of a second audio-conference system for facilitating an audio conference with virtual locations for participants in accordance with embodiments of the present invention.

FIG. 13 shows a schematic representation of a third audio-conference system for facilitating an audio conference with virtual locations for participants in accordance with embodiments of the present invention.

FIG. 14 shows a schematic representation of a fourth audio-conference system for facilitating an audio conference with virtual locations for participants in accordance with embodiments of the present invention.

### DETAILED DESCRIPTION

Embodiments of the present invention are directed to audio-conference communication systems that enable audio-conference participants to identify which of the participants are speaking. In particular, communication system embodiments exploit certain characteristics of human hearing in order to stimulate the spatial localization of audio sources, which can improve the quality of an audio conference in at least two ways: (1) Communications system embodiments can locate speakers in different virtual orientations, so that speaker recognition is significantly improved by the addition of simulated spatial cues; and (2) Communication system embodiments convert low-bandwidth mono audio to wider-bandwidth stereo, with the possible introduction of reverberation and other audio effects in order to create sound that more naturally resembles meeting-room environments, which is significantly more pleasant than usual monotone, low-quality telephone conversations.

The detailed description is organized as follows: A description of the perception of sound source location is provided in a first subsection. A description of sound spatialization using stereo headphones is provided in a second subsection. A description of various embodiments of the present invention is provided in a third subsection.

### I. Perception of Sound Source Location

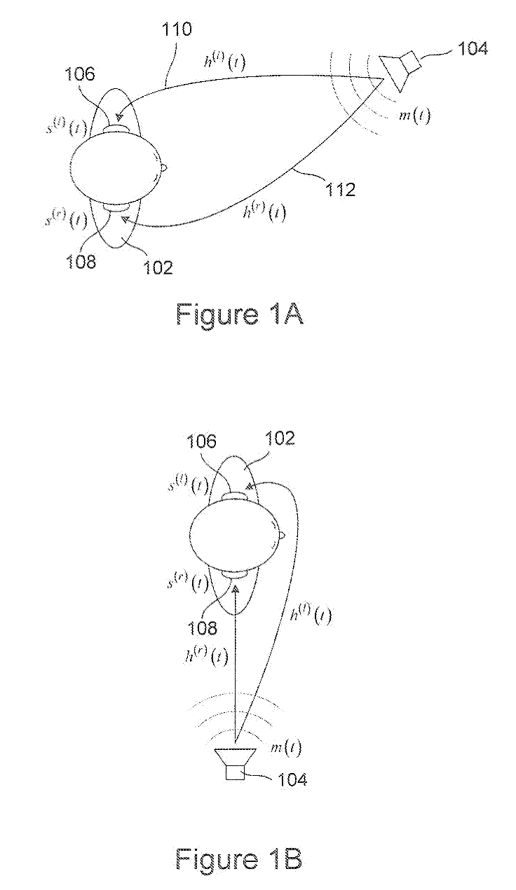

Human beings can identify the location of different sound sources using a combination of cues derived from the sounds that arrive in each ear and, in particular from the differences in the sounds arriving at each ear. FIG. 1A shows a top view of a diagram of a person 102 listening to a sound generated by a sound source 104. The sound level inside the left auditory canal of the person's left ear 106 and the sound level inside the right auditory canal inside the person's right ear are typically not identical, because the sound arriving at one ear can be affected differently than the sound arriving at the other ear. For example, as shown in FIG. 1A, the distance 110 traveled by the sound reaching the left ear 106 is shorter than the distance 112 traveled by the same sound reaching the right ear 108. Thus, the time it takes for the sound to reach the left ear 106 is shorter than the time it takes for the same sound to reach the right ear 108. The result is a sound phase difference due to the unequal distances 110 and 112. This time difference can be important in locating the location of percussion sounds. Time difference is just one factor used by the human brain to determine the location of a sound source. There are many other more subtle factors that alter the perceived sound that can also be used in locating a sound source.

Sounds are funneled into the ear canal by the ear pinna (i.e., the cartilaginous projecting portion of the external ear), which alters the perceived sound intensity depending on the direction in which the sound arrives at the ear pinna and on the frequency of the sound. Thus, sound perception can be further altered by the orientation of a person's head and shoulders with respect to the direction of the sound. For example, high-frequency sounds can be mostly blocked by a person's head. Consider the sound source 104 located on one side of the person's 102 head, as shown in FIG. 1B. The perceived intensity of a high-frequency sound originating from the source 104 on one side of the person's 102 head is higher at the right oar 108 than at the left ear 106. On the other hand, low-frequency sound originating from the source 104 diffract around the person's 102 head and can be heard with the same intensity in both ears, but it takes longer for the sound to reach the left ear 106 than it does for the same sound to reach the right ear 108. As a result, the phase and amplitude of the sounds reaching the ears 106 and 108 are changed by the size, shape, and orientation of the person's head and shoulders with respect the direction of the sound.

The above described factors, including other factors, are automatically processed by the human brain, enabling partial determination of the sound direction and possibly the location of the sound source. While it may be challenging to accurately model all of these factors, the sounds are typically modified by these factors in a linear, time-invariant manner. Thus, these factors, including ear pinna, distance, head and shoulder orientations with respect to the direction of the sound, can be artificially modeled by linear time-invariant systems with impulse responses, h^{(r)}(t) and h^{(l)}(t), as shown in FIG. 1. In other words, given a monotone sound signal m(t) representing the sound generated by the sound source 104, where t is time, the signals representing stereo sounds in the right and left auditory canals of the human ears can be mathematically determined by:

s^{(r)}(t)=(h^{(r)}*m)(t)=∫_{-∞}^{∞}h^{(r)}(τ−t)m(τ)dτ,

s^{(l)}(t)=(h^{(l)}*m)(t)=∫_{-∞}^{∞}h^{(l)}(τ−t)m(τ)dτ

In other words, the signal conveying the sound in the right auditory canal, s^{(r)}(t), can be modeled mathematically by convolving the sound signal m(t) with the impulse response h^{(r)}(t) characterizing the right car pinna, distance the sound signal travels to the right ear, and head and shoulder orientations with respect to the sound source. The signal conveying the sound in the left auditory canal, s^{(l)}(t), can likewise be modeled mathematically by convolving the sound signal m(t) with the impulse response h^{(l)}(t) characterizing the left ear pinna, distance the sound signal travels to the left ear, and head and shoulder orientations with respect to the sound source.

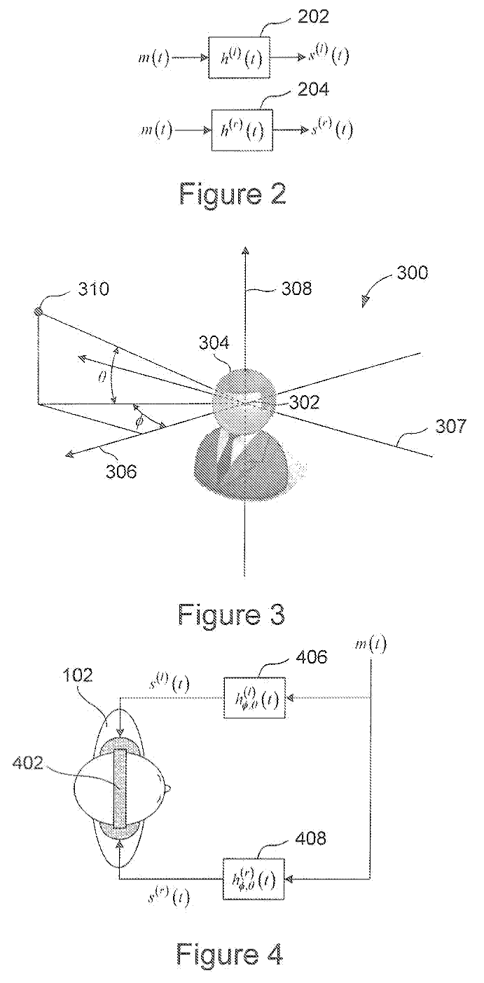

The operations performed by convolving the sound signal m(t) with the impulse response h^{(r)}(t) and h^{(l)}(t) can be thought of as filtering operations. FIG. 2 shows filters 202 and 204 schematically representing the computational operation of converting a sound signal m(t) into left and right ear auditory canal signals s^{(l)}(t) and s^{(r)}(t) by convolving, or “filtering,” the sound signal m(t) with the impulse responses h^{(l)}(t) and h^{(r)}(t), respectively.

The functions h^{(r)}(t) and h^{(l)}(t) are called head-related impulse response (“HRIRs”), and the corresponding Fourier transforms are given by:

H^{(r)}(ƒ)=∫_{-∞}^{∞}h^{(r)}(t)e^{-j2πtƒ}dt,

H^{(l)}(ƒ)=∫_{-∞}^{∞}h^{(l)}(t)e^{-j2πtƒ}dt

are called head-related transfer functions (“HRTFs”).

Each HRIR (or HRTF) can be determined by inserting microphones in the auditory canals of a person and measuring the response to a source signal emanating from a spatial location with Cartesian coordinates (x,y,z). Because HRIRs can be different for each sound source location, the HRIRs can formally be defined as a time function parameterized by the coordinates (x,y,z) and can be represented as h_{x,y,z}^{(r)}(t), and h_{x,y,z}^{(l)}(t). However, beyond a distance of about one meter from the source to the person's head, only the magnitude of the HRIR changes significantly. As a result, the azimuth angle φ, and the elevation angle, θ, can be used as parameters in a spherical coordinate system with the origin of the spherical coordinate system located at the center of the person's head and the corresponding parameterized impulse responses can be represented as h_{φ,θ}^{(r)}(t) and h_{φ,θ}^{(l)}(t). FIG. 3 shows an example of a spherical coordinate system 300 with the origin 302 of the coordinate system located at the center of a model person's head 304. Directional arrows 306-308 represent three orthogonal coordinate axes. Point 310 can represent the location of a sound source with an azimuth angle φ and elevation angle θ in the coordinate system 300.

The brain can also process changes in h_{φ,θ}^{(r)}(t) and h_{φ,θ}^{(l)}(t) to infer a sound source location through head movements. Thus, when there may be some ambiguity as to the sound source location, people instinctively move their heads in an attempt to determine the sound source location. This operation is equivalent to changing the azimuth and elevation angles φ and θ, which, in turn, modifies the signals s^{(r)}(t) and s^{(l)}(t). The perceived changes in the azimuth and elevation angles can be translated by the human brain into more accurate estimates of the sound source location.

### II. Sound Spatialization Using Stereo Headphones

In returning to FIG. 1A, it is not unreasonable to assume, that even though the HRIRs defined by the pinna, and head and shoulders orientations are not known exactly, the measured values for the HRIRs can be used to filter a recorded sound signal m(t) and stereo headphones can be used to deliver to each ear sound signals s^{(r)}(t) and s^{(l)}(t) that approximate the sounds created by the sound source 104 in a given spatial location. The signals s^{(r)}(t) and s^{(l)}(t) approximately represent the different sounds received by the right and left ears 108 and 106 and are referred to as stereo signals.

FIG. 4 shows a top view and schematic representation of using headphones 402 and stereo sound to approximate the sounds generated by the sound source 104, shown in FIG. 1A, and deliver stereo signals to the left and right ear of the person 102. As shown in the example of FIG. 4, the sound signal m(t) is split such that a portion of the signal is sent to a first filter 404 and a second portion is send to a second filter 406. The filters 404 and 406 convolve the impulse responses h_{φ,θ}^{(r)}(t) and h_{φ,θ}^{(l)}(t) with the separate sound signals m(t) in order to independently generate stereo signals s^{(r)}(t) and s^{(l)}(t) that are delivered separately to the right and left auditory canals of the person 102 using the headphones 402. The stereo signals s^{(r)}(t) and s^{(l)}(t) approximately recreate the same sound levels detected by the right and left ears of the person 102 as if the person was actually in the presence of the actual sound source 104, as describe above and represented in FIG. 1. In other words, the stereo headphones 402 and filters 404 and 406 can be used to approximately reproduce the two independent sounds inside the right and left auditory canals in stereo to create the impression of the sound emanating from a virtual location in three-dimensional space, as in natural hearing.

As shown in the example of FIG. 4, the impulse responses h_{φ,θ}^{(r)}(t) and h_{φ,θ}^{(l)}(t) represented by the filters 404 and 406 have explicit dependence on the azimuth and elevation angles, indicating that by properly adjusting the parameters of the filters 404 and 406, the sound source of the sound signal m(t) can be artificially located in any virtual space location that is sufficiently far from the head of the person 102. In other words, the parameters θ and φ can be adjusted so that a person perceives the stereo effect of a sound signal emanating from a particular virtual location.

Based on the above described assumption, and assuming that the HRIRs are approximately the same for all persons listening to the headphones, nearly any sound environment and nearly any configuration of sound source can be reproduced for a listener. A set of universal HRIRs can be recorded and used to recreate many different types of sound environments. Another approach is to record sounds to determine the HRIRs by inserting microphones into the ears of a mannequin, because these sounds, in theory, should be altered in the same way they are by a human listener in a technique called “binaural recording.”

While these assumptions may seem reasonable, in practice, it has been observed that the resulting sound experiences may not be as realistic as expected. However, certain binaural recordings may result in better experiences of sound ambiance, when played on headphones, but the results may be uneven and may be difficult to predict. Similarly, the sound created using universal HRIRs may be convincing for some people, but much less convincing for others.

There are several reasons why these approaches for recreating a perceived location of audio sources may not work as well as expected. First, there are differences in the shape and size of each person's head, shoulders, pinna, and auditory canal. In other words, each person has a unique set of HRIRs, and each person has already learned how to process sounds for their own head, shoulders, pinna, and auditory canal to locate sound sources. Thus, the spatial perception of a sound created using a specific HRIR depends on how well the HRIR approximates the listener's. Second, head movements are important for locating a sound source. The human brain very quickly identities as unnatural that with common headphones the sound characteristics do not change with even significant head rotations.

The second problem can be alleviated by using headphones that identify orientation, for example, using an electronic compass, accelerometer, or combination of such sensors. Using this information, it may be possible to change the HRIRs in real time to compensate for head movements.

### III. Embodiments of the Present Invention

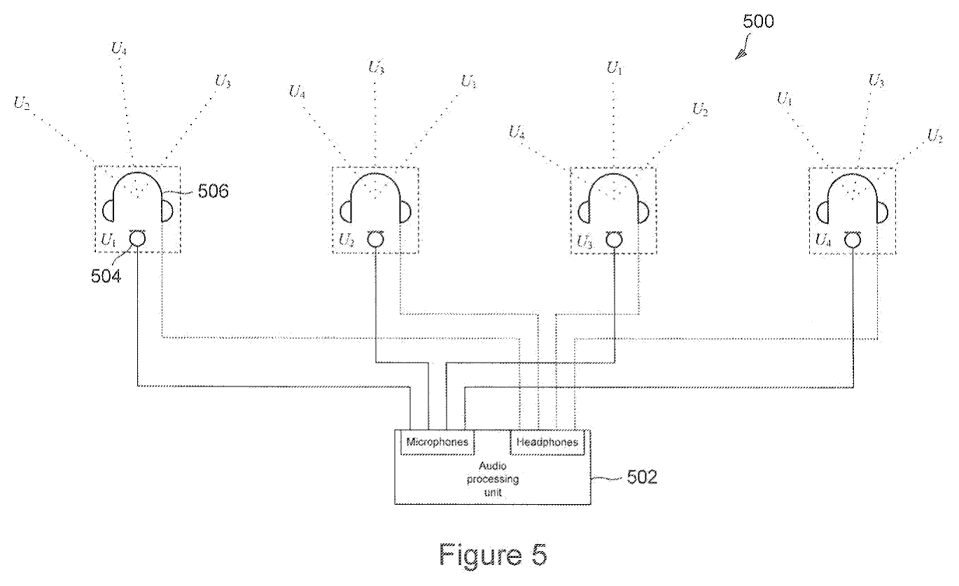

FIG. 5 shows a schematic representation of an audio conference 500 with virtual participant locations in three-dimensional space for participant identification in accordance with embodiments of the present invention. As shown in the example of FIG. 5, the audio conference 500 includes an audio-processing unit 502 configured to provide audio conferencing for four audio conference participants identified as U₁, U₂, U₃, and U₄. Each participant is equipped with a microphone and headphones, such as microphone 504 and headphones 506 provided to participant U₁. Sound signals generated by each participant are sent from the microphones to the audio-processing unit 502. The sound signals are processed so that each participant receives a different stereo signal associated with each of the other participants. For example, as shown in the example of FIG. 5, participant U₁ receives a stereo signal from each of the other participants U₂, U₃, and U₄. The audio-processing unit 502 is configured and operated so that each participant receives a stereo signal produced by convolving the sound signals of the other participants with a unique sets of HRIR (or HRTFs) corresponding to different azimuth and elevation values assigned to the other participants. The result is that each participant receives a different stereo signal associated with the other participants creating the impression that each of the other participants is speaking from a different virtual location in space, as indicated by dotted lines. For example, participant U₂ receives the stereo signals from the other participants U₁, U₃, and U₄. For participant U₂, the audio-processing unit 502 assigns to each of the other participants U₁, U₃, and U₄ a particular set of azimuth and elevation angles in producing separate corresponding stereo signals. Thus, participant U₂ perceives that the other participants are speaking from different virtual locations and, therefore, more easily determine which of the other participants is speaking. Embodiments of the present invention are not limited to four participants in an audio conference. Embodiments of the present invention can be configured and operated to accommodate as few as two participants to more than four participants.

In general, for a set of N individual participants represented by a set u={U₁, U₂, . . . U_{N}} participating in an audio conference with each participant's microphone generating a sound signal mᵢ(t) and receiving stereo signals sᵢ^{(r)}(t) and sᵢ^{(l)}(t) with iε{1, 2, . . . , N}. As described above in subsection II, a virtual location of a speaking participant Uᵢ relative to a listening participant Uⱼ can be modeled by selecting relative azimuth and elevation angles φ_{i,j} and θ_{i,j} and using corresponding HRIRs for filtering mᵢ(t) as follows:

$$\begin{matrix}{s}_{j}^{( r )} ( t ) = {\sum }_{i = 1}^{N} {s}_{j , i}^{( r )} ( t ) = {\sum }_{i = 1}^{N} ( {h}_{{φ}_{i , j} {θ}_{i , j}}^{( r )} * {m}_{i} ) ( t ) & Equation ( 1 ) \\ {s}_{j}^{( l )} ( t ) = {\sum }_{i = 1}^{N} {s}_{j , i}^{( l )} ( t ) = {\sum }_{i = 1}^{N} ( {h}_{{φ}_{i , j} {θ}_{i , j}}^{( l )} * {m}_{i} ) ( t ) & Equation ( 2 )\end{matrix}$$

In practice, digital communication systems actually transmit discrete-time) sampled signal sequences mᵢ[n], sᵢ^{(r)}[n], and sᵢ^{(l)}[n] sampled from analog signals mᵢ(t), sᵢ^{(r)}(t) and sᵢ^{(l)}(t). Similarly the discrete-time version of the HRIR filters h_{i,j}^{(□)}[n] are used to represent the discrete-time filter response corresponding to h_{φ}_{_{i,j}}_{θ}_{_{i,j}}^{(□)[n].}

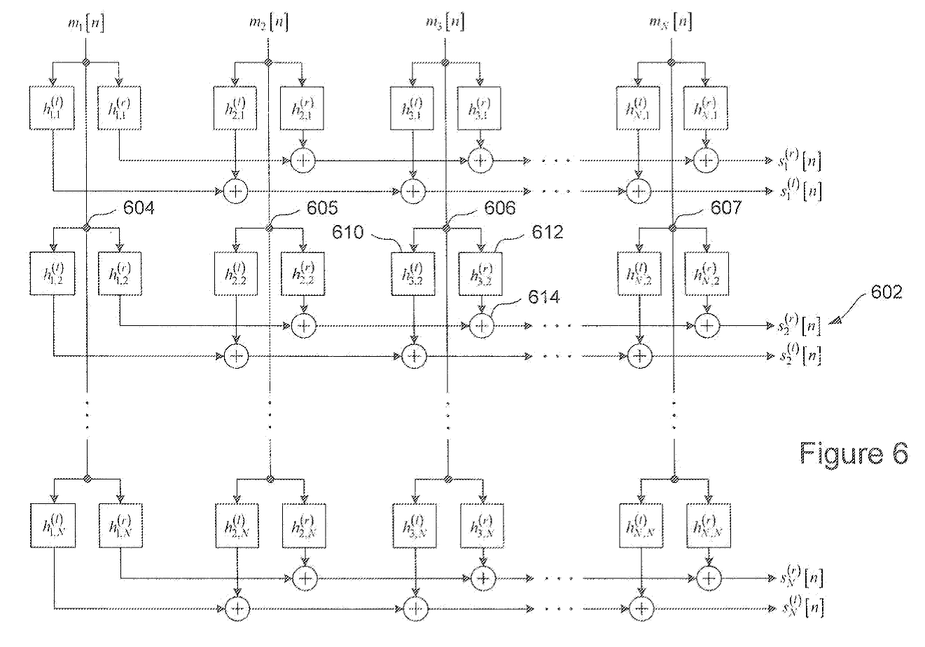

FIG. 6 shows a diagram of N sound signals filtered and combined to create N stereo signals in accordance with embodiments of the present invention. Each filter h_{i,j}^{(□)}[n] is assumed to be pre-selected. In other words, the virtual location of each of the participants can be pre-determined when an audio conference begins. Each row of filters corresponds to filtering operations performed on each of the sampled sound signals mᵢ[n] provided by N microphones in order to generate the stereo signals sⱼ^{(r)}[n] and sⱼ^{(l)}[n] sent to the jth participant. Consider, for example, the filtering and combining operations performed in generating the stereo signals s₂^{(r)}[n] and s₂^{(l)}[n] 602 sent to the second participant U₂. As shown in the diagram of FIG. 6, each of the N sound signals mᵢ[n] is split, as represented by dots 604-607, and separately processed by a left filter and a right filter to generate a pair of stereo signals s_{i,2}^{(r)}[n] and s_{i,2}^{(l)}[n] output from each pair of filters. For example, the sound signal m₃[n] sent from the third participant's U₃ microphone is split such that a first portion is processed by a left filter 610 and a second portion is processed by a right filter 612, and the output from the left and right filters 610 and 612 are stereo signals s_{3,2}^{(r)}[n] and s_{3,2}^{(l)}[n] to a particular pre-selected virtual location for the third participant U₃ which is perceived by the second participant U₂ upon listing to the stereo signals s_{3,2}^{(r)}[n] and s_{3,2}^{(l)}[n]. The signals output from the right filters are combined at summing junctions, such as summing junction 614, to produce the right ear stereo signal s₂^{(r)}[n], and the output from the left filters are combined at summing junctions to produce the left ear stereo signal s₂^{(l)}[n]. The stereo signals s₂^{(r)}[n] and s₂^{(l)}[n] when heard by the second participant U₂ reveal the pre-selected virtual location of each of the other N-1 participants.

Note that FIG. 6 reveals that a total of 2N filtering operations can be performed. On the other hand, assuming that a speaking participant's speech feedback does not need to be filtered, (i.e., h_{i,i}^{(r)}[n]≡1 and h_{i,i}^{(l)}[n]≡1), the total number of filtering operations can be reduced from 2N to 2N (N-1).

Because each impulse response h_{i,j}^{(□)}[n] can be long, it may be computationally more efficient to compute the convolutions in the frequency domain using the Fast Fourier Transform (“FFT”). The efficiency gained may be significant where the same sound signal may pass through several different filters. For example, as shown in FIG. 6, the sound signal m₃[n] passes through N separate left and right filters in computing the N separate stereo signals.

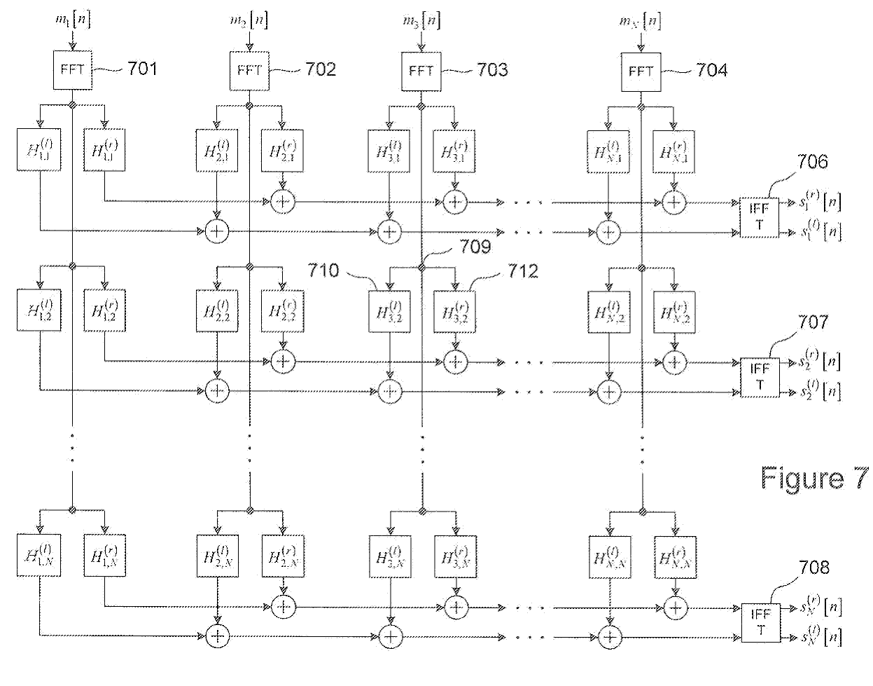

FIG. 7 shows a diagram of N sound signals filtered and combined in the frequency domain to create N stereo signals in accordance with embodiments of the present invention. As shown in the diagram of FIG. 7, each of the sound signals mᵢ[n] passes through an FFT filter, such as FFT filters 701-704. The diagram includes inverse Fast Fourier Transforms (“IFFT”) filters, such as IFFT filters 706-708, to obtain time-domain stereo signals stereo signals sⱼ^{(r)}[n] and sⱼ^{(l)}[n] for each of the participants. For example, the sound signal m₃[n] generated by the third participant's U₃ microphone passes through FFT filter 703 to obtain a frequency domain sound signal M₃[k] which is split 709 such that a first portion is processed by a left frequency domain filter 710 and a second portion is processed by a right frequency domain filter 712. The output from the left and right filters 710 and 712 are frequency domain stereo signals S_{3,2}^{(r)}[k] and S_{3,2}^{(l)}[k], which are combined at summing junctions with the frequency domain stereo signals S_{i,2}^{(r)}[k] and S_{i,2}^{(l)}[k] obtained from the other frequency-domain right and left filters and passed through the IFFT 707 to produce the time-domain stereo signals s₂^{(r)}[n] and s₂^{(l)}[n].

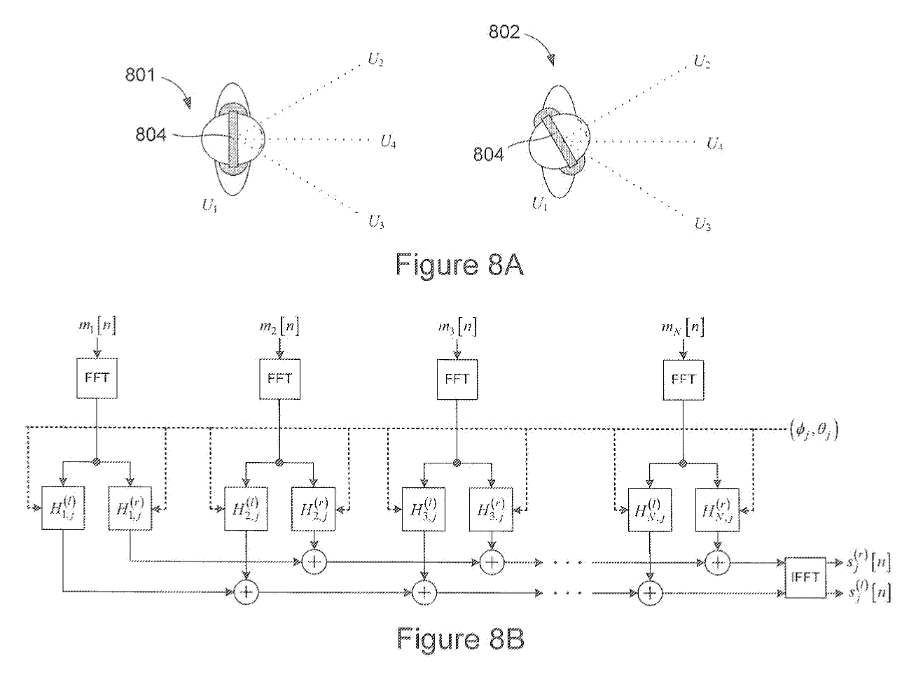

In the systems of FIGS. 6 and 7, the HRIRs (and HRTFs) are assumed to be constant. In other words, the virtual locations of the participants are assumed to be pre selected and do not change during the conference. However, in other embodiments, the headphones can be configured with head-orientation sensors and the HRIRs (and HRTFs) change accordingly with the head movements of the participants in order to maintain the virtual locations of the speaking participants. FIG. 8A shows top views 801 and 802 of a listening participant U₁ and virtual locations for three other speaking participants U₂, U₃, and U₄ as perceived by the participant U₁ in accordance with embodiments of the present invention. In FIG. 8A, the participant U₁ can be assumed to be using headphones 804 with head-direction sensors the provide azimuth and elevation information associated with the head orientation of participant U₁. As shown in the example of FIG. 8A, top views 801 and 802 reveal that even though the azimuth and elevation information obtained from the headphones 804 are different, the participant U₁ does not detect a substantially change in the virtual locations of speaking participants U₂, U₃, and U₄.

FIG. 8B shows a diagram of how sound signals are processed with head-orientation data to create stereo signals for a participant in accordance with embodiments of the present invention. As shown in the diagram of FIG. 8B, the azimuth and elevation angles φⱼ and θⱼ of the participant Uⱼ are used to change the filters associated with the frequency domain left and right impulse responses. As a result, stereo signals sent to the participant Uⱼ can be adjusted depending on the participant Uⱼ's head orientation so that the virtual locations of the speaking participants are perceived as unchanged by the participant Uⱼ.

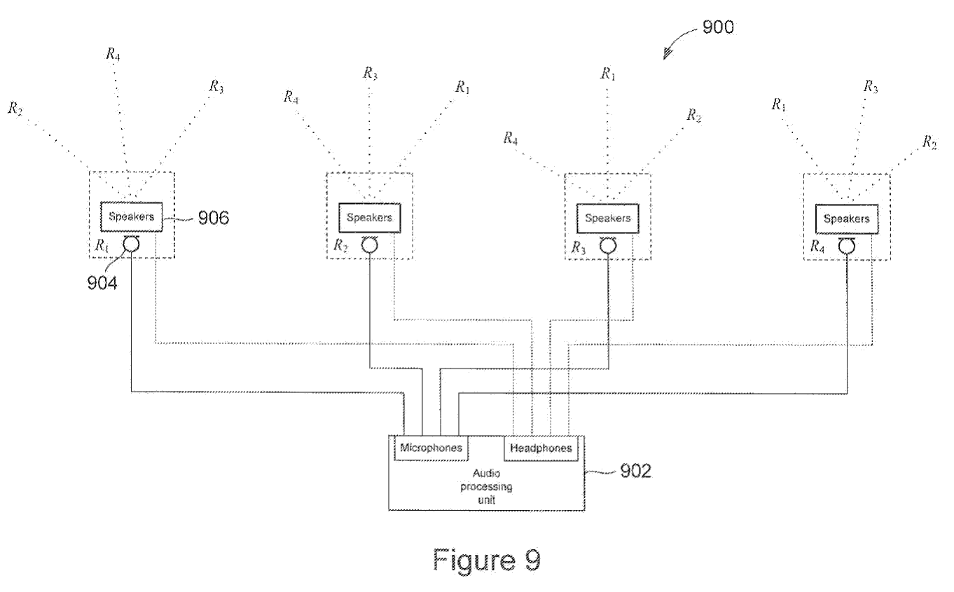

Embodiments of the present invention are not limited to audio conferences where individual participants wear headphones. In other embodiments, headphones can be replaced by stereo speakers mounted in room, where the conference is conducted between participants located in different rooms at different locations. The stereo sounds produced at the speakers can be used in the same manner as the stereo sounds produced by the left and right headphone speakers by creating a virtual location for each room participating in the audio conference. FIG. 9 shows a schematic representation of an audio conference 900 with virtual room locations in three-dimensional space for participant identification in accordance with embodiments of the present invention. The audio conference 900 includes an audio-processing unit 902 configured to provide audio conferencing for participants located in four different conference rooms identified as R₁, R₂, R₃, and R₄. Each room is equipped with at least one microphone and one or more pairs of stereo speakers or any other devices for generating stereo sound, such as microphone 904 and stereo speakers 906 in room R₁. Sound signals generated by participants in each room are sent from the microphones to the audio-processing unit 902. The sound signals are processed so that each room receives a different stereo signal for each of the other rooms. For example, as shown in the example of FIG. 9, participants in room R₁ receive stereo signals from each of the other rooms R₂, R₃, and R₄ and these stereo signals are played over stereo speakers 906. Like the audio-processing unit 502, the audio-processing unit 902 is also configured and operated so that each room receives the stereo signal of the other room convolved with a unique sets of HRIR (or HRTFs) corresponding to different azimuth and elevation values assigned to each room. The result is that the participants in each room hear different stereo signals, each of which are associated with creating the impression the participants in the other rooms are speaking from different virtual locations in space, as indicated by the dotted lines. For example, participants in the room R₂ receive the stereo signals associated with rooms R₁, R₃, and R₄. For participants in room R₂, the audio-processing unit 902 assigns to the stereo signals generated in each of the other rooms R₁, R₃, and R₄ a unique set of azimuth and elevation angles in producing separate corresponding stereo signals. Thus, participants in room R₂ perceive that the participants in the room R₁ are speaking from a first virtual location, the participants in the room R₃ are speaking form a second virtual location, and the participants in the room R₄ are speaking from a third virtual location. Embodiments of the present invention are not limited to four rooms used in an audio conference.

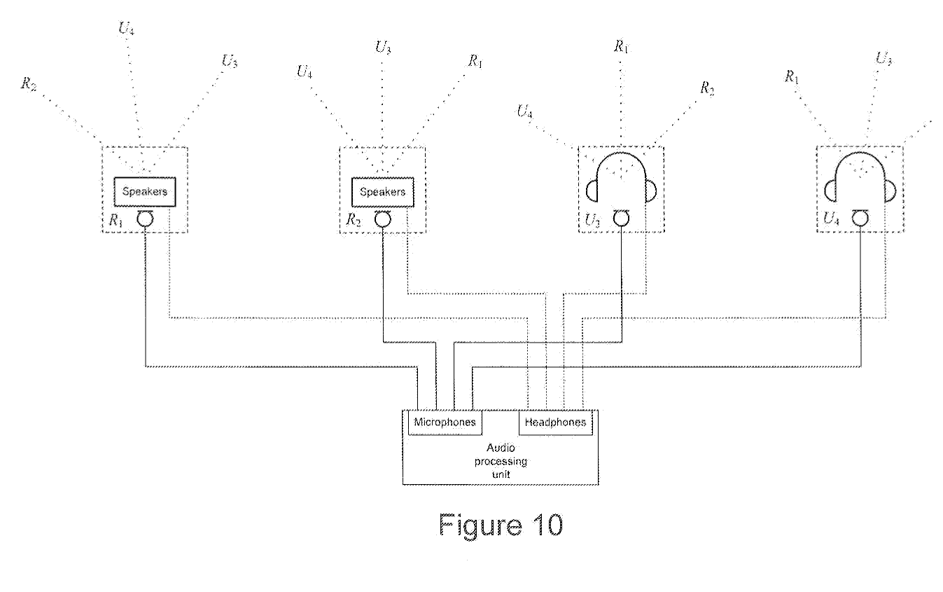

Embodiments of the present invention also includes combining participants with headphones, as described above with reference to FIG. 5, with participants in rooms, as described above with reference to FIG. 9. FIG. 10 shows a schematic representation of an audio conference 1000 with simulated three-dimensional locations of rooms and individual participants participating in an audio conference in accordance with embodiments of the present invention. The audio conference 1000 is configured to accommodate individual participants U₃ and U₄ wearing headphones and participants located in separate rooms R₁ and R₂.

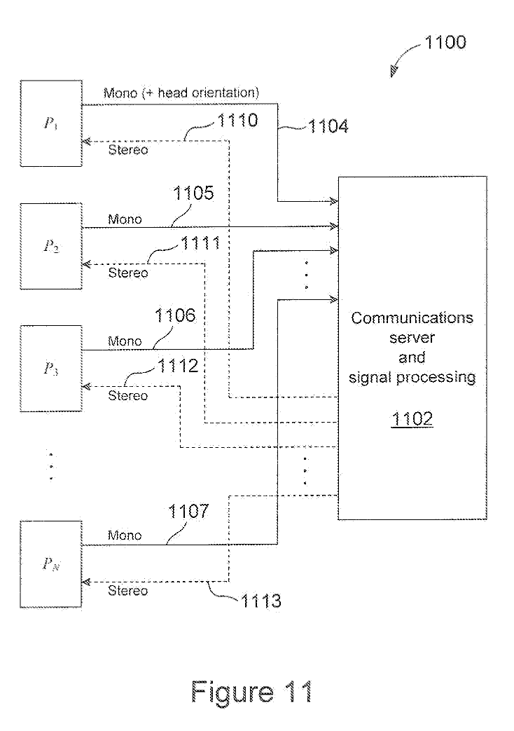

FIG. 11 shows an audio-conference system 1100 for producing audio conferences with virtual three-dimensional orientations for participants in accordance with embodiments of the present invention. As shown in the example of FIG. 11, the participants, four of which are represented by P₁, P₂, P₃, and P_{N}, can be combinations of individuals wearing headphones and equipped with microphones, as described above with reference to FIG. 5, and rooms configured with one or more pairs of stereo speakers and one or more microphones so that one or more people located in each room can participate in the audio conference, as described above with reference to FIG. 9. The system 1100 includes a communications server 1102 that manages routing of signals between conference participants and carries out the signal processing operations described above with reference to FIGS. 6-8. As shown in the example of FIG. 11 and in subsequent Figures, solid lines 1104-1107 represent electronic coupling microphones to the server 1102, and dashed lines 1110-1113 represent electronic coupling stereo sound generating devices, such as stereo speakers or headphones, to the server 1102. Each participant sends one sound signal, and may optionally send one head-orientation signal for individual participants, to the communications server 1102. The communications server 1102, in turn, generates and sends back to each of the N participants stereo signals comprising the sum of three-dimensional simulated stereo signals associated with the virtual locations of the other participants, as described above with reference to FIGS. 6-8. For example, participant P₂ receives the stereo signals s₂^{(r)}[n] and s₂^{(l)}[n] comprising the sum of the stereo signals associated with each of the other N-1 participants P₁ and P₃ through R_{N}, as described above with reference to FIGS. 6-8. Because each of the participants has been assigned a unique azimuth and elevation in a virtual space, participant P₂ can identify each of the N-1 participants by the unique associated virtual location when the participants P₁ and P₃ through P_{N} speak. In the system 1100, each participant can assign a particular virtual space location for the other participants. In other word, each of the participants can arrange the other participants in any virtual spatial configuration stored by the communications server 1102. In other embodiments, the server 1102 can be programmed to select the arrangement of speakers in any virtual spatial configuration. Note that embodiments of the present invention are not limited to implementations with a single communications server 1102, but can be implemented using two or more communications servers.

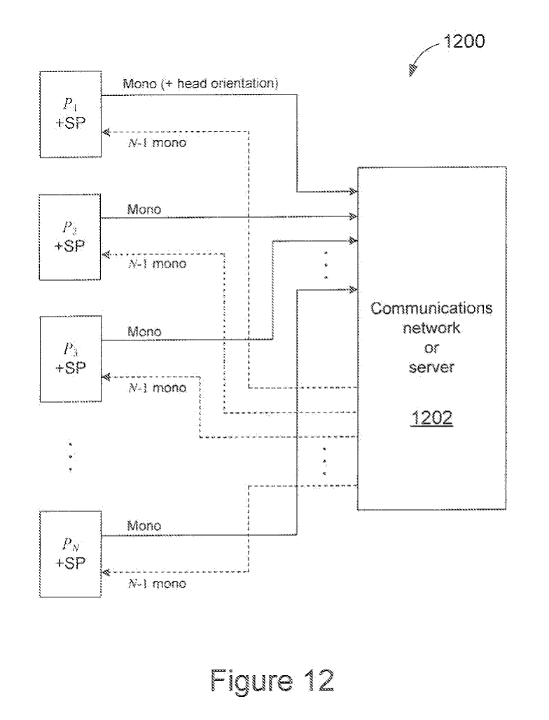

In other embodiments, rather than centralizing the signal processing to one or more communications servers, each of the participants can include a computational device enabling each participant to perform local signal processing. FIG. 12 shows an audio-conference system 1200 for facilitating an audio conference with virtual three-dimensional orientations for the other participants determined separately by each participant in accordance with embodiments of the present invention. The system 1200 includes a communications network or server 1102 that manages routing of sound signals between conference participants. In particular, the server 1102 is configured to receive sound signals form each of the N participants and sends back to each participant the other N-1 sound signals produced by the other participants. For example, the participants all send sound signals to the server 1202, and participant P₂ receives from the server 1202 N-1 sound signals produced by the other participants P₁ and P₃ through P_{N}. Each participant includes a computational device for performing signal processing. A processing device can be, but is not limited to, a desktop computer, a laptop, a smart phone, a telephone, or any other computational device that is suitable for performing local signal processing. Thus, each participant can arrange the other participants in any virtual spatial configuration for an audio conference, and each participant generates a stereo signal associated with each of the other N-1 participants. The stereo signals comprise the sum of three-dimensional simulated stereo signals associated with the virtual locations of the other participants. For example, when participant P₂ receives the N-1 sound signals from the server 1202, participant P₂ performs signal processing as described above with reference to FIGS. 6-8 to generate the stereo signals s₂^{(r)}[n] and s₂^{(l)}[n]. Each of the other N-1 participants can be assigned, by participant P₂, a unique azimuth and elevation in a virtual space. Thus, participant P₂ can identify each of the N-1 participants by a unique associated virtual location when the participants P₁ and P₃ through P_{N} speak.

Because the signal processing is being performed locally by each participant in the system 1200, processing additional local head-orientation information for individual participants, as described above with reference to FIG. 8, may be more efficiently performed locally by individual participants than at a central location, such as the communications server 1102 described above with reference to FIG. 11. In addition, because no signal processing is actually being performed at the communications server 1202, the total network bandwidth for the system 1200 may be much higher than the bandwidth provided by the system 1100 where signal processing and networking is performed by the same communications server 1102.

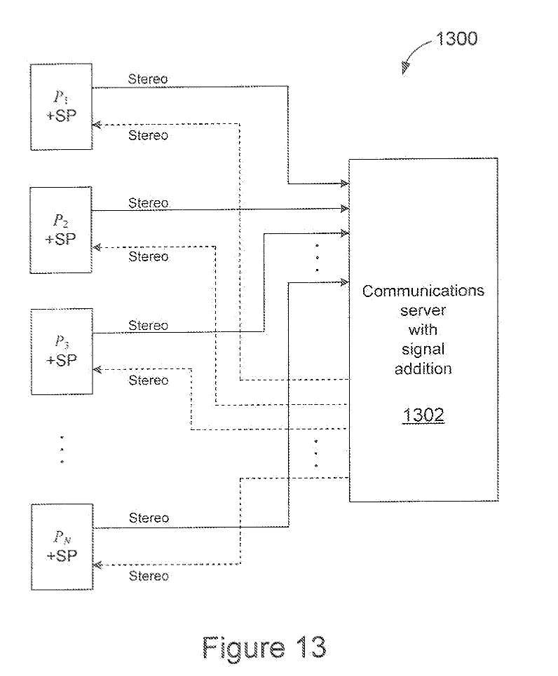

In other embodiment, the signals processing can be performed locally, and to further reduce network bandwidth and computational complexity, the set of virtual spatial locations for the participants can be constrained. FIG. 13 shows an audio-conference system 1300 for facilitating an audio conference with virtual three-dimensional orientations constrained in accordance with embodiments of the present invention. The system 1300 includes a communications server 1302 that manages routing of stereo signals generated by each of the participants between conference participants. Participants agree on a particular virtual spatial location assignments for each participant, which is the same for all participants. For example, during an audio conference, participant P₁ perceives virtual spatial locations for the participants P₃ through P_{N}, and, during the same audio conference, participant P₂ also perceives the same virtual spatial locations for the participants P₃ through P_{N}. Thus, each participant locally generates its own stereo signal by convolving sound signals generated by the participant with its assigned HRIR (or assigned HRTF) corresponding to its virtual spatial location. This stereo signal is then sent to the server 1303. For each participant, the server 1302 receives one stereo signal and sends the stereo signal with an average of the other stereo signals to each of the other N participants.

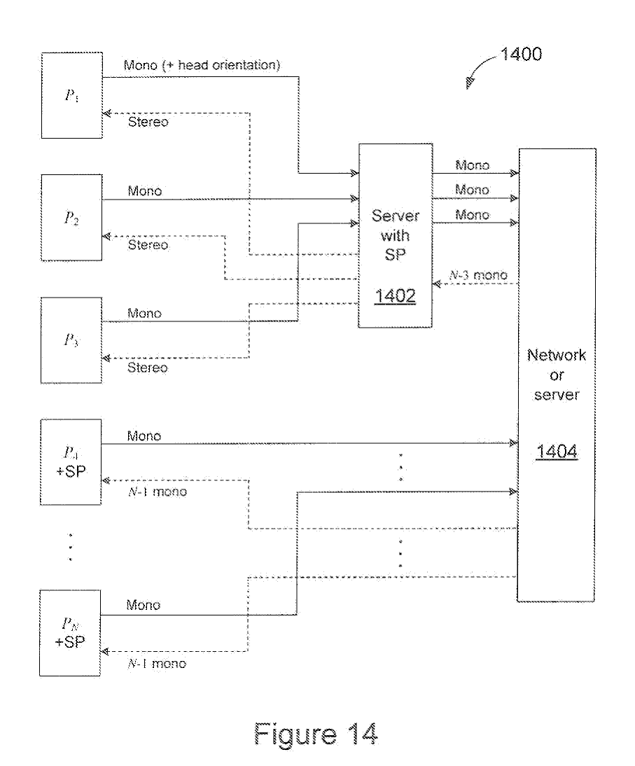

Audio-conference system embodiments of the present invention can also be configured to accommodate participants capable of performing localized signal processing and participants that are not capable of performing localized signal processing. FIG. 14 shows a schematic representation of an audio-conference system 1400 configured to accommodate participants capable, and not capable, of performing localized signal processing in accordance with embodiments of the present invention. The system 1400 includes a first communications server 1402 that receives sound signals from participants that are not capable of performing local signal processing, represented by participants P₁, P₂, and P₃, as described above with reference to FIG. 11. The system 1400 also includes a second communications server 1404 that receives sound signals from the participants with computational devices for performing signal processing represented by participants P₄ through P_{N}, as described above with reference to FIG. 12. As shown in the example of FIG. 14, the server 1402 sends the sound signals generated by the participants P₁, P₂, and P₃ to the server 1404. The server 1404 is configured to receive the N sound signals and send back to each of the N-3 participants P₄ through P_{N} N-1 sound signals produced by the other participants. For example, participant P₄ receives the N-1 sound signals produced by the participants P₁, P₂, P₃, and P₅ through P_{N} from the server 1404. Each of the participants P₄ through P_{N} includes a computation device for performing localized signal processing as described above with reference to FIG. 12. The server 1404 also sends the N-3 sound signals generated by the participants P₄ through P_{N} to the server 1402. The server 1402 is configured to receive the N-3 sound signals generated by the participants P₄ through P_{N} and perform signal processing with the N-3 sound signals and the sound signals generated by each of the participants P₁, P₂, and P₃, as described above with reference to FIG. 11.

Note that embodiments of the present invention are not limited to dividing the routing and signal processing operations of the system 1400 between two servers 1402 and 1404. In other embodiments, one or more communications servers can be configured to perform the same operations performed the two servers 1402 and 1404.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. An audio-communication system comprising:
at least one communications server;
a plurality of stereo sound generating devices, each stereo sound generating device electronically coupled to the at least one communications server and
a plurality of microphones electronically coupled to the at least one communications servers, each microphone detecting different sounds that are sent to the at least one communications server as corresponding sound signals, wherein the at least one communications server converts the sound signals into corresponding stereo signals that when combined and played over each of stereo sound generating devices creates an impression for a person listing to any one of the stereo sound generating devices that each of the sounds emanates from a different virtual location in three-dimensional space.

2. The system of claim 1 wherein the stereo sound generating device further comprise one of headphones or a pair of stereo speakers.

3. The system of claim 1 wherein the at least one communications server further comprises a computing device configured to receive sound signals and route the combined stereo signal to each of the stereo sound generating devices.

4. The system of claim 1 wherein the at least one communications server converts each sound signal into a corresponding stereo signal further comprises the at least one communications server cons oh each of the sound signals with a pair of left ear and right ear head-related impulse responses, each pair of left ear and right ear head-related impulse responses corresponding to a different virtual location in three-dimensional space for the sound detected by a microphone.

5. The system of claim 1 wherein the at least one communications server converts each sound signal into a corresponding stereo signal further comprises the at least one communications server transforms each sound signal from the time domain into a frequency-domain sound signal, convolves each of the frequency-domain sound signals with a pair of left ear and right ear head-related transfer functions in the time domain or the frequency domain, each pair of head-related transfer functions corresponding to a different virtual location for a sound detected by a microphone, and transforms the frequency-domain stereo signals into the time domain.

6. The system of claim 1 wherein one or more of the stereo sound generating devices further comprises a head-orientation sensor in electronic communication with the at least one communications server.

7. The system of claim 6 wherein the head-orientation sensor sends electronic signals to the at least one communications server identifying a listener's head orientation such that the at least one communications server adjusts the combined stereo signals sent to the stereo sound generating device to maintain the virtual positions of the corresponding sounds heard by the listener.

8. An audio-communication system comprising:
at least one communications server;
a plurality of stereo sound generating devices;
a plurality of computing devices, each computing device electronically coupled to one of the stereo sound generating devices and the at least one communications server; and
a plurality of microphones electronically coupled to the at least one communications server, each microphone detecting different sounds that are sent to the at least one communications server as corresponding sound signals, wherein the at least one communications server combines the sound signals and sends the combined sound signals to each of the computational devices, wherein each computing device converts the sound signals into corresponding stereo signals that when combined and played over each of stereo sound generating devices creates an impression for a person listing to any one of the stereo sound generating devices that each of the sounds emanates from a different virtual location in three-dimensional space.

9. The system of claim 8 wherein the stereo sound generating device further comprise one of headphones or a pair of stereo speakers.

10. The system of claim 8 wherein at least one communications server further comprises a computing device configured to receive sound signals from each of the microphones, combine the sound signals, and send the combined sound signals to each of the computing devices.

11. The system of claim 8 wherein each computing device converts each sound signal into a corresponding stereo signal further comprises the at least one communications server convolves each of the sound signals with a pair of left ear and right ear head-related impulse responses, each pair of left ear and right ear head-related impulse responses corresponding to a different virtual location for the sound detected by a microphone.

12. The system of claim 8 wherein each computing device converts each sound signal into a corresponding stereo signal further comprises the at least one communications server transforms each sound signal from the time domain into a frequency-domain sound signal, convolves each of the frequency-domain sound signals with a pair of left ear and right ear head-related transfer functions frequency-domain stereo signals, each pair of head-related transfer functions corresponding to a different virtual location for a sound detected by a microphone, and transforms the frequency-domain stereo signals into the time domain.

13. The system of claim 8 wherein one or more of the stereo sound generating devices further comprises a head-orientation sensor in electronic communication with the at least one communications server.

14. The system of claim 13 wherein the head-orientation sensor sends electronic signals to the at least one communications server identifying a listener's head orientation such that the at least one communications server adjusts the combined stereo signals sent to the stereo sound generating device to maintain the virtual positions of the corresponding sounds heard by the listener.

15. An audio-communication system comprising:
at least one communications server;
a plurality of computing devices electronically coupled to the at least one communications server;
a plurality of stereo sound generating devices, each stereo sound generating device electronically coupled to one of the computing devices; and
a plurality of microphones, each microphone electronically coupled to one of the computing devices, wherein each microphone detects sounds that are sent to the electronically coupled computing device as sound signals, wherein each electronically coupled computing converts sound signals into corresponding stereo signals that are sent to the at least one communications server, which combines the stereo signals, such that when the combined stereo signals are played over each of the stereo sound generating devices creates an impression for a person listing to any one of the stereo sound generating devices that each of the sounds emanates from a different virtual location in three-dimensional space.

16. The system of claim 15 wherein the stereo sound generating device further comprise one of headphones or a pair of stereo speakers.

17. The system of claim 15 wherein the at least one communications server further comprises a computing device configured to receive stereo signals, combined stereo signals, and sends the combined stereo signals to each of the stereo sound generating devices.

18. The system of claim 15 wherein each computing device converts each sound signal into a corresponding stereo signal further comprises the at least one communications server convolves each of the sound signals with a pair of left car and right ear head-related impulse responses, each pair of left ear and right ear head-related impulse responses corresponding to a different virtual location for the sound detected by a microphone.

19. The system of claim 15 wherein each computing device converts each sound signal into a corresponding stereo signal further comprises the at least one communications server transforms each sound signal from the time domain into a frequency-domain sound signal, convolves each of the frequency-domain sound signals with a pair of left ear and right ear head-related transfer functions frequency-domain stereo signals, each pair of head-related transfer functions corresponding to a different virtual location for a sound detected by a microphone, and transforms the frequency-domain stereo signals into the time domain.
